(19) United States
(12) Patent Application Publication
(10) Pub. No.: US 2010/0254155 A1
(43) Pub. Date: Oct. 7, 2010

(54) Simulated Candle and Method For Simulating a Candle

(75) Inventors: Rosa CAPO, Troy, NY (US); Patricia RIZZO, Clifton Park, NY (US); Jean Paul FREYSSINIER-NOVA, Troy, NY (US)

Correspondence Address: HESLIN ROTHENBERG FARLEY & MESITI PC, 5 COLUMBIA CIRCLE, ALBANY, NY, 12203, US

(73) Assignee: RENSSELAER POLYTECHNIC INSTITUTE, Troy, NY (US)

(21) Appl. No.: 12/755,510

(22) Filed: Apr. 7, 2010

Related U.S. Application Data
(60) Provisional application No. 61/167,411, filed on Apr. 7, 2009.

(51) Int. Cl. G02B 6/04

(52) U.S. Cl. 362/554

(57) ABSTRACT

Simulated candles and methods of simulating a candle are disclosed. The simulated candles include a cylindrical housing having an open top, a plurality of LEDs positioned in the housing, a plurality of optical fibers positioned to receive and transmit light from the plurality of LEDs through the open top of the housing, and a translucent conical light diffuser mounted about the plurality of optical fibers to simulate the appearance of a candle flame. The housing may simulate a candle taper, and may include simulated wax drippings. The simulated candle may include a power source and control electronics positioned within the housing. The color of the LEDs is selected to provide the realistic appearance of a lit candle, for example, the appearance of historically accurate candle, such as, a spermaceti candle.

### CROSS-REFERENCE TO RELATED APPLICATION

This application claims priority from pending U.S. Provisional Patent Application 61/167,411 filed on Apr. 7, 2009, the disclosure of which is included by reference herein in its entirety.

### STATE FUNDED RESEARCH

This invention was made with New York State support under contract J50486 awarded by the New York State Energy Research and Development Authority (NYSERDA). New York State has certain rights in the invention.

### BACKGROUND OF THE INVENTION

1. Technical Field

The present invention generally relates to simulated candles. More particularly, the present invention relates to simulated candles illuminated by light-emitting diodes and optic fibers arranged to simulate a candle flame.

2. Description of Related Art

Historically, candles have been made from a variety of substances, including natural waxes, tallow, and fats. With the increase in commercial whaling in the 1700s, a new source of material for use in candle manufacturing was encountered. A waxy material substance found in the head of the sperm whale proved to be an effective alternative to existing candle making materials. This material, known as “spermaceti,” was used to make candles that, when lit, provided a distinctive candle glow that is typically associated with the candles of that time period, that is, the late 1700s. However, with advances in candle technology and limited availability of spermaceti, most candles are now made from paraffin. However, there remains an interest and need for reproducing the appearance of the glow of the “spermaceti candle,” for example, for historic museum displays, among other uses.

Aspects of the present invention address this need by providing candles and methods for making candles employing state of the art lighting technology to simulate the glow of a candle, in particular, the glow of a spermaceti candle.

Simulated candles, for example, candles using light-emitting diodes (LEDs) exist in the art, but their appearance and operation do not accurately portray the glow or general appearance of a historic candle, for example, a spermaceti candle. Spermaceti candles, for example, typically have a soft, golden white color with a blue or black core. Typical prior art simulated candles are orange in color and have little or no flame variation, that is, the desired flame variation or flicker that is typical of candles. These prior art simulated candles typically appear to be “fake.”

Aspects of the present invention address this and other disadvantages of prior art simulated candles.

### SUMMARY OF THE INVENTION

Aspects of the present invention, marketed under the name Washington Headquarters™ Candle due to its simulation of a candle that may be found lighting the service quarters of General George Washington, employ fiber optics and light-emitting diodes (LEDs) to simulate the glow of a spermaceti candle. In one aspect of the present invention, optic fibers illuminated by light sources, such as, LEDs, channel blue light tones to the core of the simulated flame and channel warm white and amber light tones to the surrounding outer portions of the simulated flame to provide a more realistic flame appearance.

Aspects of the invention have been found to provide historically accurate replicas of the spermaceti candles typically found in historic museums, but without the cost and safety issues associated with open flames. For example, museum or other historic displays are not only exposed to public traffic, but also can be housed in period, typically, wood-frame structures. Aspects of the present invention provide a historically accurate flame for stationary display and for use in touring historic structures while avoiding injuring the staff and public, and preventing the exposure of flammable material to open flame. Aspects of the invention, not only simulate a historic flame, for example, that of a spermaceti candle, but also can provide a light source for illumination and display.

One aspect of the invention is a simulated candle comprising or including a cylindrical housing having an open top; a plurality of light sources positioned in the housing; and a plurality of optical fibers having first ends positioned to receive and transmit light from the plurality of light sources and second ends projecting through the open top of the housing; wherein the second ends of the plurality of optical fibers are arranged to simulate a candle flame. The candle may be adapted to simulate a spermaceti candle, as described above. The plurality of light sources may typically comprise a plurality of light-emitting diodes (LEDs), for example, amber, blue, and white LEDs. In one aspect, the candle further comprises a power supply and a light controller positioned in the housing. At least some of the plurality of optical fibers may be twisted together to intermingle colored light transmitted by the plurality of optical fibers.

Another aspect of the invention is a method of simulating a candle comprising or including positioning a plurality of optic fibers in a cylindrical housing having an open top whereby the plurality of optics fibers have first ends in the housing and second ends extending through the open top of the housing; directing light from a plurality of light sources into the first ends of the plurality of optic fibers, transmitting the light through the plurality of optic fibers, and emitting the light transmitted out the second ends of the plurality of optic fibers; and diffusing the light emitted out of at least some the second ends of the plurality of optic fibers to simulate a flame of a candle. In one aspect of the method, the plurality of light sources may be a plurality of LEDs of varying color, for example, amber, blue, and white LEDs. In another aspect, the method includes transmitting light emitted from the second ends of at least some of the plurality of optic fibers though a translucent portion of the top of the housing to simulate a candle.

A further aspect of the invention is a simulated candle comprising or including a cylindrical housing having an open top; a plurality of LEDs positioned in the housing; a plurality of optical fibers having first ends positioned to receive and transmit light from the plurality of LEDs and second ends projecting through the open top of the housing and emitting the light received from the plurality of LEDs; and a conical light diffuser mounted about the second ends of the plurality of optical fibers; wherein the second ends of the plurality of optical fibers are arranged within the light diffuser wherein the light emitted from the plurality of LEDs simulates a candle flame. Again, the plurality of LEDs may emit a plurality of colors of light, for example, blue, amber, and white. In one aspect, at least some of the plurality of optical fibers may be twisted together to intermingle the blue, amber, and white colors emitted by the LEDs. The simulated candle may simulate a spermaceti candle, as described above.

Another aspect of the invention is the artificial candle as shown and described herein, and the ornamental design for an artificial candle, for example, the ornamental design for an artificial spermaceti candle, as shown and described herein. Another aspect of the invention is the ornamental design for an artificial candle flame, for example, the ornamental design for an artificial spermaceti candle flame, as shown and described herein.

These and other aspects, features, and advantages of this invention will become apparent from the following detailed description of the various aspects of the invention taken in conjunction with the accompanying drawings

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter, which is regarded as the invention, is particularly pointed out and distinctly recited in the claims at the conclusion of the specification. The foregoing and other objects, features, and advantages of the invention will be readily understood from the following detailed description of aspects of the invention taken in conjunction with the accompanying drawings, in which:

FIG. 1 is a schematic diagram of a simulated candle according to one aspect of the invention.

FIG. 2 is a schematic diagram of one array of light sources and fiber optics that can be used in the aspect of the invention shown in FIG. 1.

FIG. 3 is a schematic cross section of an elevation view of another aspect of the invention.

FIG. 4 is a schematic cross section of an elevation view of another aspect of the invention.

FIG. 5 is a schematic cross section of an elevation view similar to FIG. 4 of another aspect of the invention.

FIG. 6 is a photograph of a perspective view of the illuminated fiber optics in a housing according to an aspect of the invention.

FIG. 7 is a photograph of an actual candle flame that is simulated by aspects of the invention.

FIG. 8 is a photograph of a simulated candle according to an aspect of the invention as the aspect illuminates a hand.

FIG. 9 is a photograph of a simulated candle according to an aspect of the invention.

### DETAILED DESCRIPTION OF THE INVENTION

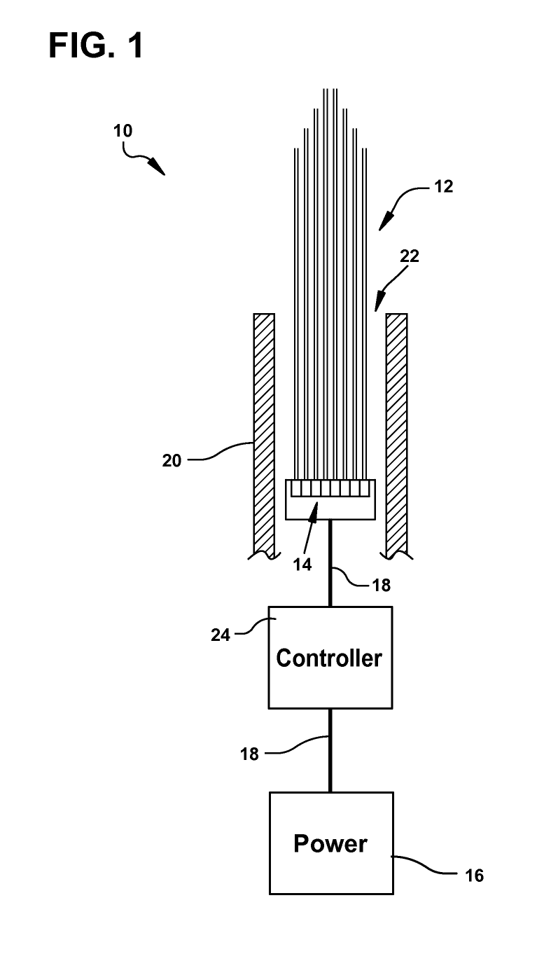

FIG. 1 is a schematic electrical diagram of a simulated candle assembly 10 according to one aspect of the invention. Candle assembly 10 includes a plurality of optical fibers 12, a plurality of light sources 14, for example, light-emitting diodes (LEDs), positioned to direct light into and along the optical fibers 12, and a power supply 16 adapted to provide appropriate electrical power to light sources 14, for example, via electrical connection 18. According to aspects of the present invention, the colors of light sources 14 are chosen to provide the appropriate colored illumination of optical fibers 12 to provide a desired optical effect, for example, the simulation of a candle flame, for instance, the simulation of a spermaceti candle flame.

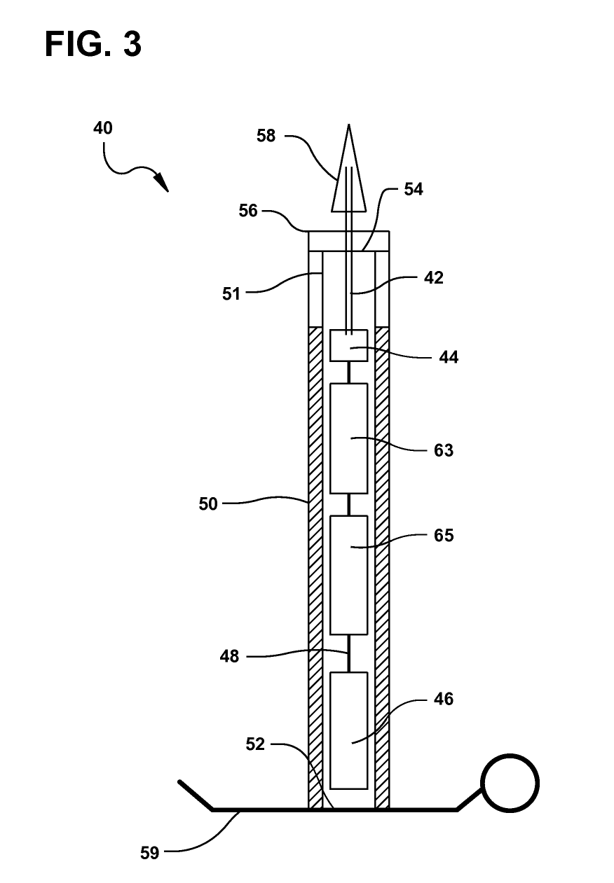

As shown in FIG. 1, at least some of optical fibers 12 may be housed in an elongated, cylindrical housing 20, for example, a hollow, circular cylindrical housing, simulating a conventional candle, for instance, spermaceti candle. In FIG. 1, only a representative cross section of housing 20 is shown. It will be understood by those of skill in the art, that housing 20 may typically have the shape and appearance, for example, with simulated wax drippings, of an elongated candle taper. Housing 20 may have an open first end (not shown), for example, to permit access by connection 18 and the like, and an open second end 22 through which optical fibers 12 extend. As shown in FIG. 3 below, second end 22 may be closed or obstructed to more accurately simulate a candle.

Though for the sake of illustration, optical fibers 12 in FIG. 1 are shown as substantially straight elongated fibers, according to aspects of the invention, fibers 12 may be twisted, intermingled, oriented, and otherwise positioned to provide the desired visual effect. For example, in one aspect, fibers 12 transmitting one color of light may be twisted or intermingled with fibers transmitting another, different color of light. In addition, fibers 12 of varying colors may be juxtaposed to provide the desired visual effect, as will be discussed below.

As shown in FIG. 1, candle assembly 10 may also include one or more controllers 24 adapted to control, modify, or regulate the electrical power transmitted by power supply 16 to light sources 14. Controller 24 may simply be a resistor to limit the current directed to light sources 14. However, controller 24 may also typically have some form of intelligence or logic by which the illumination of light source 14 can be regulated and controlled to provide a desired visual effect, for example, a flickering flame. Controller 24 may include a power boost converter and/or a light-flickering circuit, among other controlling devices. Controller 24 may comprise one or more printed circuit boards (PCBs), not shown, containing one or more devices, as are conventional. Controller 24 may be positioned within or outside of housing 20.

Power supply 16 may be any conventional electrical power supply, for example, a transformer plugged into a wall outlet. However, power supply 16 may typically comprise one or more dry cell batteries, such as, AA or AAA batteries or button-type batteries.

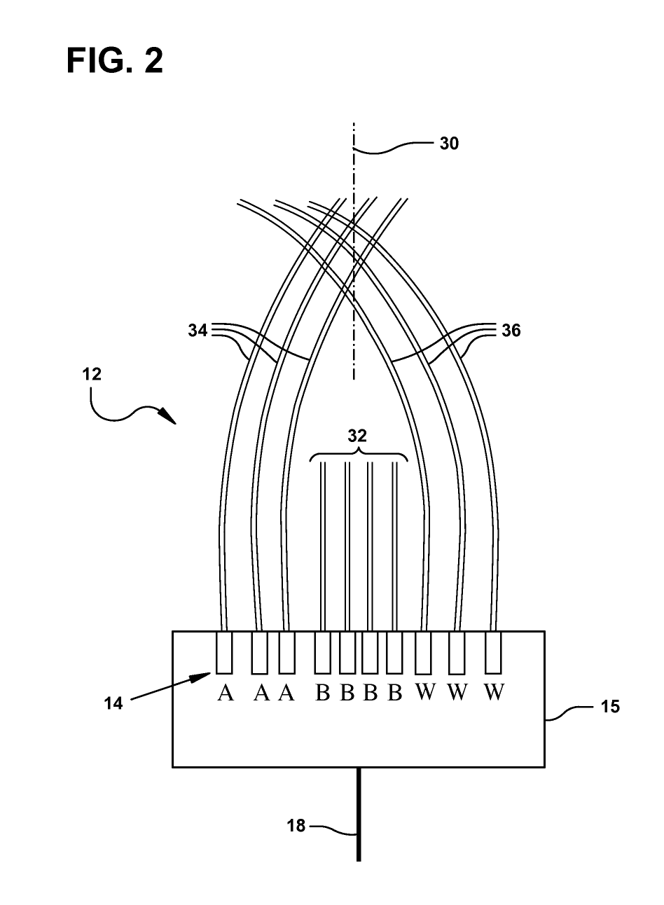

FIG. 2 is a schematic diagram of one array of light sources 14 and optic fibers 12 that can be used in the aspect of the invention shown in FIG. 1. As shown in FIG. 2, a plurality of light sources 14, for example, LEDs, may be arranged in a platform 15, for example, a PCB, in proximity to a plurality of fiber optics 12. As described above, light sources 14 may be powered via electrical connection 18. According to aspects of the invention, light sources 14 may comprise a single color or a plurality of colors. Light sources 14 may be incandescent bulbs, fluorescent bulbs, or individual lasers, among other conventional colored or non-colored light sources. In the aspect of the invention shown in FIG. 2, light sources 14 comprise a plurality of LEDs of varying color. Though many different color LEDs and LED arrangements may be used according to aspects of the invention, in the aspect shown in FIG. 2, the LEDs 14 and fiber optics 12 are shown in a single plane for ease of illustration. However, it is to be understood that the arrangement of LEDs 14 and fibers 12 shown in FIG. 2 may comprise a broad range of layouts and arrangements. In the view shown in FIG. 2, only a single view of a substantially axi-symmetric arrangement of LEDs 14 and optic fibers 12 is shown. For example, each LED 14 and fiber 12 in FIG. 2 may represent one of a series of LEDs 14 and optic fibers 12 arranged in a circular fashion about an axis 30 of optic fibers 12. Alternate arrangements of LEDs and fibers 12 will be apparent to those of skill in the art.

Again, though a broad range and combination of different colors of LEDs, or other light sources, 14 may be used, in the aspect of the invention shown in FIG. 2, one or more blue (B) LEDs, may be surrounded by one or more amber (A) LEDs and one or more white (W), for example, warm white, LEDs. The inventors have found through experimentation that this combination of color LEDs may most effectively simulate the color of an actual candle, for example, an actual spermaceti candle. Again, though one aspect of the invention may employ blue, amber, and white LEDs, the only limit to the number, combination, and range of colors that may be used is the colors of available light sources, for example, the colors available from LEDs.

As shown in FIG. 2, each LED 14 is typically associated with one or more optic fibers 12. In the aspect shown, blue LEDs B are positioned to direct light into one or more optic fibers 32; amber LEDs A are positioned to direct light into one or more optic fibers 34; and white LEDs W are positioned to direct light into one or more optic fibers 36. In one aspect of the invention, a single LED 14 or other light source may direct light into one or more fibers 32, 34, 36 or one or more LEDs 14 or other light sources may direct light into a single fiber 32, 34, 36.

As shown in FIG. 2, according to one aspect of the invention, optic fibers 32 associated with the blue LEDs may be positioned about the axis 30 and may be shorter than fibers 34 and 36 to provide a central blue base to the simulated flame to more accurately simulate an actual flame. Fibers 34 and 36 may be longer than fibers 32 and may be positioned radially outward of fibers 32. Similarly, amber LEDs A and white LEDs W may also be positioned radially outward from blue LEDs B. Again, this positioning and combination of fibers 34, 35 and LEDs A and W can provide an outer golden glow to the simulated flame to more accurately simulate an actual flame. Though shown as distinct isolated fibers in FIG. 2, fibers 32, 34, and 36 may be intermingled, for example, twisted about each other or juxtaposed adjacent to each other, to more accurately recreate the desired visual appearance. For example, fibers 34 and 36 may be intermingled and/or twisted to combine the amber and white color they transmit to provide the desired golden glow of the simulated flame.

FIG. 3 is a schematic cross section of an elevation view of another candle assembly 40 according to another aspect of the invention. Candle assembly 40 includes a plurality of optical fibers 42, a plurality of light sources 44, for example, the array of LEDs 14 shown in FIG. 2, positioned to direct light into and along the optical fibers 42, and a power supply 46 adapted to provide appropriate electrical power to light sources 44, for example, via electrical connection 48. According to aspects of the present invention, the color of light sources 44 are chosen to provide the appropriate colored illumination of optical fibers 42 to provide a desired optical effect, for example, the simulation of a candle flame, for instance, the simulation of a spermaceti candle flame.

As shown in FIG. 3, in this aspect of the invention, optical fibers 42, light sources 44, and power supply 46 may be housed in an elongated, hollow, cylindrical housing 50, for example, a circular cylindrical housing, simulating a conventional candle, for instance, a spermaceti candle. It will be understood by those of skill in the art, that housing 50 may typically have the shape and appearance, for example, with simulated wax drippings, of an elongated candle taper. Housing 50 may typically be made from a plastic. Housing 50 may have an open first end 52, for example, to permit access to power supply 46 and the like, and an open second end 54 through which optical fibers 42 extend. As shown in FIG. 3, second end 54 may be closed or obstructed by a cover or top 56 to more accurately simulate the appearance of a candle.

As also shown in FIG. 3, candle assembly 40 may also include a candle holder or tray 59 upon which housing 50 may be mounted, for example, by mechanical fasteners.

For ease of illustration, optical fibers 42 in FIG. 2 are shown as single, substantially straight elongated fiber; however, as discussed above, according to aspects of the invention, fibers 42 may typically comprise a plurality of long or short, twisted, intermingled, juxtaposed, oriented, and otherwise positioned fibers to provide the desired visual effect. In one aspect, the plurality of fibers may be tightly twisted to more readily display a wick-type structure.

As shown in FIG. 3, candle assembly 40 may also include one or more controllers 63, 65 adapted to control, modify, or regulate the electrical power transmitted by power supply 48 to light sources 44. Controllers 63, 65 may be positioned within the hollow opening of housing 50. Controller 63 may include a power boost converter and controller 65 may be a light-flickering circuit, among other controlling devices. Controllers 63, 65 may be mounted on one or more PCBs (not shown) positioned within housing 50.

According to one aspect of the present invention, housing 50 may include at least a portion 51 that is at least partially translucent whereby light from light sources 44 may at least partially visible through portion 51. At least partially translucent portion 51 further enhances the appearance and accuracy of simulation of candle assembly 40 by simulating the illuminated wicked end of a candle. In addition, in another aspect, open end 52 of housing 50 may include a cover 56 which, again, may be at least partially translucent to the light from light sources 44 to further simulate a real candle. Cover 56 typically may include an opening through which fibers 42 may pass.

As also shown in FIG. 3, candle assembly 40 may also include a light diffuser 58 mounted about optic fibers 42 to diffuse the light emitted by optic fibers 42 and more accurately portray the appearance of a candle flame. According to an aspect of the invention, the function of the light diffuser 58 is to diffuse and blend at least some of the light emitted by the optic fibers (for example, the blue and amber light of the fibers with the white light emitted from the optic fibers). The diffuser 58 may also be shaped to provide the appearance of a candle flame. For example, light diffuser 58 may be conical in shape and have a hollow interior to accommodate the internal fibers. The diffuser may be made from an elastomer, for example, a rubber; a plastic; a ceramic; or a glass and have an appropriate translucence to provide at least some diffusion of the light emitted by optic fibers 42. In one aspect, diffuser 58 may be made from a translucent rubber. Light diffuser 58 may also function to protect optic fibers 42 and light sources 44 from damage, for example, should the candle be dropped.

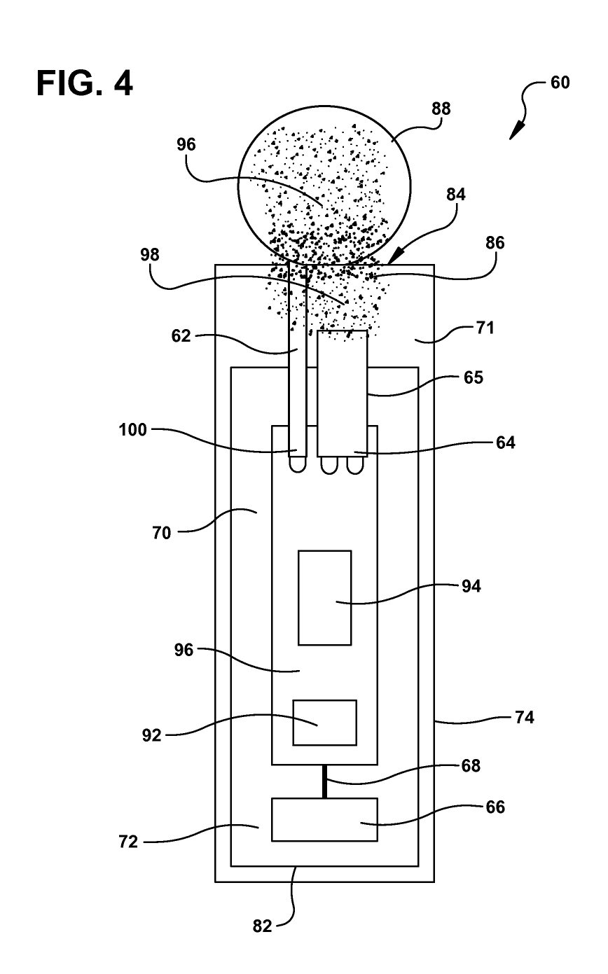

FIG. 4 is a schematic cross section of an elevation view of another candle assembly 60 according to another aspect of the invention. Candle assembly 60 includes a plurality of optical fibers 62, a plurality of light sources 64, for example, LEDs, for instance, the array of LEDs 14 shown in FIG. 2, positioned to direct light into and along the optical fibers 62, and a power supply 66 adapted to provide appropriate electrical power to light sources 64, for example, via electrical connection 68. According to aspects of the present invention, the colors of light sources 64 (for example, 5 mm LEDs) are chosen to provide the appropriate colored illumination of optical fibers 62 to provide a desired optical effect, for example, the simulation of a candle flame, for instance, the simulation of a spermaceti candle flame.

In one aspect of the invention, the coupling between optical fibers 62 and light sources 64, for example, LEDs, provides an improved fiber optic to LED coupling design 100.

As shown in FIG. 4, in this aspect of the invention, optical fibers 62, light sources 64, and power supply 66 may be housed in an elongated, hollow, cylindrical housing 70, for example, a circular cylindrical housing, simulating a conventional candle, for instance, a spermaceti candle. Housing 70 may also be non-circular in cross section, for example, square, rectangular, or elliptical in cross section. It will be understood by those of skill in the art, that housing 70 may typically have the shape and appearance, for example, with simulated wax drippings, of an elongated candle taper. Housing 70 may typically be made from a plastic, for example, housing 70 may have an inner layer 72 made of an opaque material and an outer layer 74 designed to simulate a wax candle, for example, designed to simulate the appearance of a spermaceti candle.

Housing 70 may have a first end 82, for example, an open first end to permit access to power supply 66, and the like, and an open second end 84 through which optical fibers 62 extend. As shown in FIG. 4, second end 84 may be closed or obstructed by a cover or top 86 to more accurately simulate the appearance of a candle.

For ease of illustration, optical fibers 62 in FIG. 4 are shown as a bundle of single, substantially straight elongated fibers; however, as discussed above, according to aspects of the invention, fibers 62 may typically comprise a plurality of long or short, twisted, intermingled, juxtaposed, oriented, and otherwise positioned fibers to provide the desired visual effect. In one aspect, the plurality of fibers may be tightly twisted, for example, to provide a mixed fiber optic 96, or to more readily display a wick-type structure.

As shown in FIG. 4, candle assembly 60 may also include one or more controllers or devices 92, 94 adapted to control, modify, or regulate the electrical power transmitted by power supply 66 to light sources 64. Controllers 92, 94 may be positioned within housing 70 as shown, though controllers 92, 94 may reside outside of housing 70, for example, in a support structure, such as, in or on candle holder 59, shown in FIG. 3. Device 92 may be a power boost converter and device 94 may be a light-flickering circuit, among other controlling devices. Controllers or devices 92, 94 may be mounted on one or more PCBs 96, for example, positioned within housing 70.

According to one aspect of the present invention, housing 70 may include at least a portion 71 that is at least partially translucent whereby light from at least some of light sources 64 may at least partially visible through portion 71. At least partially translucent portion 71 further enhances the appearance and accuracy of simulation of candle assembly 60 by simulating the illuminated wicked end of a candle. In addition, in another aspect, open end 82 of housing 70 may include a cover 86 which, again, may be at least partially translucent to the light from light sources 64 to further simulate a real candle. Cover 86 typically may include an opening through which fibers 62 may pass or extend.

As also shown in FIG. 4, candle assembly 60 may also include a light diffuser 88 mounted about optic fibers 62 to diffuse the light emitted by optic fibers 62 and more accurately portray the appearance of a candle flame. Light diffuser 88 may be a conical rubber, plastic, ceramic, or glass device, as described above with respect to diffuser 58, having an appropriate translucence to provide at least some diffusion of the light emitted by optic fibers 62.

In one aspect of the invention, at least one or more of optic fibers 62 may be positioned to illuminate the translucent portion 71 and/or translucent cover 86 to create a more realistic glowing effect at the second end 84 of housing 70 of candle assembly 60. For example, one or more fibers 65 may be shorter than other fibers 64 whereby the ends of fibers 65 illuminate translucent portion 71 and/or cover 86.

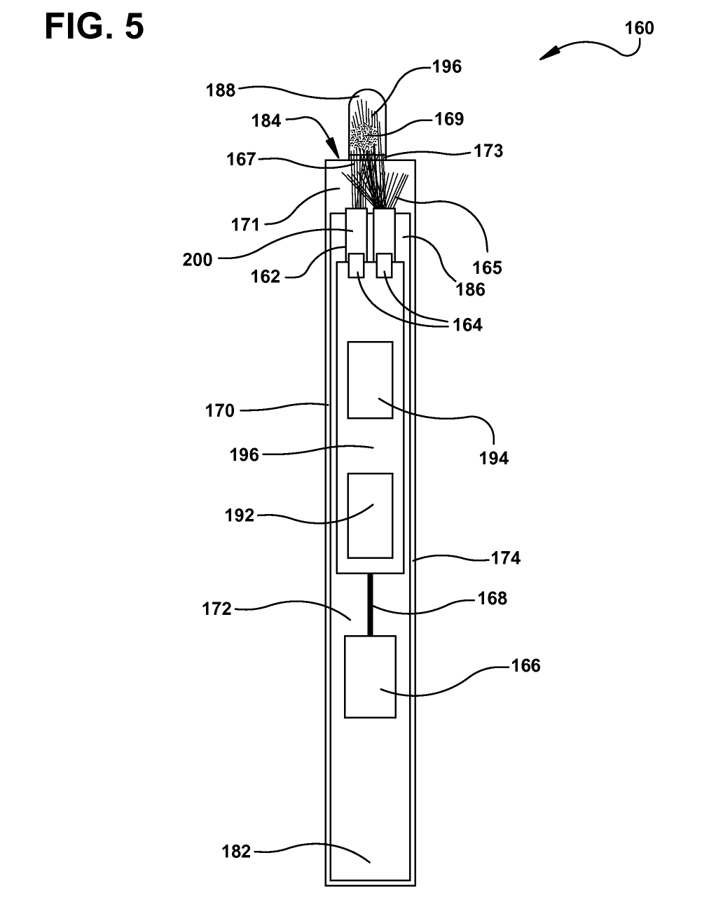

FIG. 5 is a schematic cross section of an elevation view similar to FIG. 4 of another candle assembly 160 according to another aspect of the invention. Candle assembly 160 includes a plurality of optical fibers 162, a plurality of light sources 164, for example, LEDs, for instance, the array of LEDs 14 shown in FIG. 2, positioned to direct light into and along the optical fibers 162, and a power supply 166 adapted to provide appropriate electrical power to light sources 164, for example, via electrical connection 168. According to aspects of the present invention, the colors of light sources 164 (for example, 5 mm LEDs) are chosen to provide the appropriate colored illumination of optical fibers 162 to provide a desired optical effect, for example, the simulation of a candle flame, for instance, the simulation of a spermaceti candle flame.

In one aspect of the invention, the coupling between optical fibers 162 and light sources 164, for example, LEDs, provides an improved fiber optic to LED coupling design 200.

As shown in FIG. 5, in this aspect of the invention, optical fibers 162, light sources 164, and power supply 166 may be housed in an elongated, hollow, cylindrical housing 170, for example, a circular cylindrical housing, simulating a conventional candle, for instance, a spermaceti candle. It will be understood by those of skill in the art, that housing 170 may typically have the shape and appearance, for example, with simulated wax drippings, of an elongated candle taper. Housing 170 may typically be made from a plastic, for example, housing 170 may have an inner layer 172 made of an opaque material and an outer layer 174 designed to simulate a wax candle, for example, designed to simulate the appearance of a spermaceti candle.

Housing 170 may have a first end 182, for example, an open first end to permit access to power supply 166, and the like, and an open second end 184 through which optical fibers 162 extend. As shown in FIG. 5, second end 184 may be closed or obstructed by a cover or top 186 to more accurately simulate the appearance of a candle.

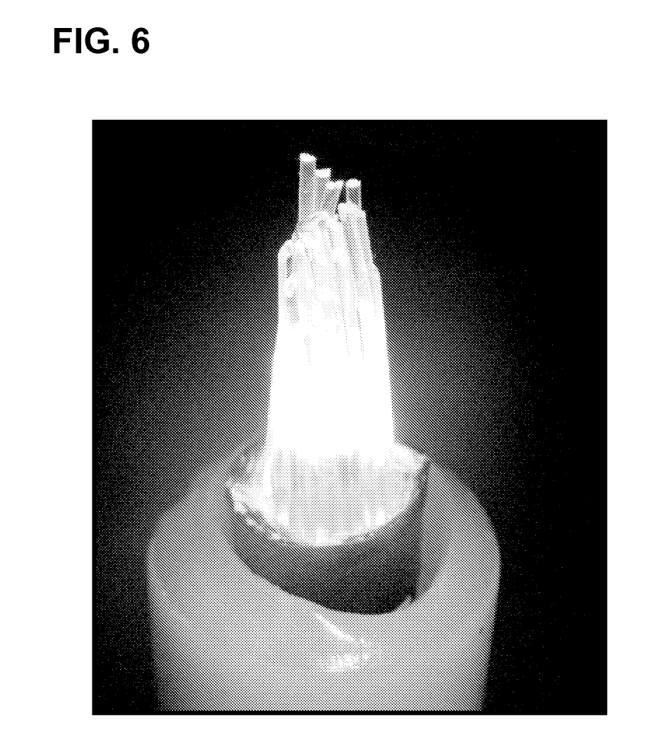

For ease of illustration, optical fibers 162 in FIG. 5 are shown as a bundle of single, substantially straight elongated fibers; however, as discussed above, according to aspects of the invention, fibers 162 may typically comprise a plurality of long or short, twisted, intermingled, juxtaposed, oriented, and otherwise positioned fibers to provide the desired visual effect, for example, as shown in FIG. 2 or in FIG. 6. In one aspect, the plurality of fibers may be tightly twisted, for example, to provide a mixed fiber optic 196, or to more readily display a wick-type structure.

As shown in FIG. 5, candle assembly 160 may also include one or more controllers or devices 192, 194 adapted to control, modify, or regulate the electrical power transmitted by power supply 166 to light sources 164. Controllers 192, 194 may be positioned within housing 170 as shown, though controllers 192, 194 may reside outside of housing 170, for example, in a support structure, such as, in or on candle holder 59, shown in FIG. 3. Device 192 may be a power boost converter and device 194 may be a light-flickering circuit, among other controlling devices. Controllers or devices 192, 194 may be mounted on one or more PCBs 196, for example, positioned within housing 170.

According to one aspect of the present invention, housing 170 may include at least a portion 171 that is at least partially translucent whereby light from at least some of light sources 164 may at least partially visible through portion 171. At least partially translucent portion 171 further enhances the appearance and accuracy of simulation of candle assembly 160 by simulating the illuminated wicked end of a candle. In addition, in another aspect, open end 182 of housing 170 may include a cover 186 which, again, may be at least partially translucent to the light from light sources 164 to further simulate a real candle. Cover 186 typically may include an opening through which fibers 162 may pass or extend.

As also shown in FIG. 5, candle assembly 160 may also include a light diffuser 188 mounted about optic fibers 162 to diffuse the light emitted by optic fibers 162 and more accurately portray the appearance of a candle flame. Light diffuser 188 may be a conical rubber, plastic, ceramic, or glass device, as described above with respect to diffuser 58 or 88, having an appropriate translucence to provide at least some diffusion of the light emitted by optic fibers 162.

In one aspect of the invention, at least one or more of optic fibers 162 may be positioned to illuminate the translucent portion 171 and/or translucent cover 186 to create a more realistic glowing effect at the second end 184 of housing 170 of candle assembly 160. For example, one or more fibers 165 may be shorter than other fibers 164, for example, shorter than blue light transmitting optic fibers 167 and white light transmitting optic fibers 169, whereby the ends of fibers 165 illuminate translucent portion 171 and/or cover 186. In one aspect, candle assembly 160 may include a black tip or projection 173 that mimics or simulates an actual candle wick. In another aspect of the invention, at least some of the light emitted by a light source, for example, an LED, may be baffled or muted to regulate the amount of light transmitted. For example, in one aspect, one of the white LEDs, for example, a warm white LED, may be shielded, for example, by means of a piece of opaque material, such as, tape, whereby light is directed to the sides of the candle and prevented from emitting upward and impacting the appearance of the other LEDs, for example, to avoid “washing out” an amber light transmitted by the optic fibers. Other baffling and muting structures may be provided as needed to regulate the transfer and emittance of light as desired to effect the desired candle appearance.

FIG. 6 is a photograph of a perspective view of the illuminated fiber optics in a housing according to an aspect of the invention. As shown in FIG. 6, in one aspect, blue light illuminates the base of the simulated flame and amber and white illuminate the body and top of the flame to provide a desired appearance, for example, of a spermaceti candle.

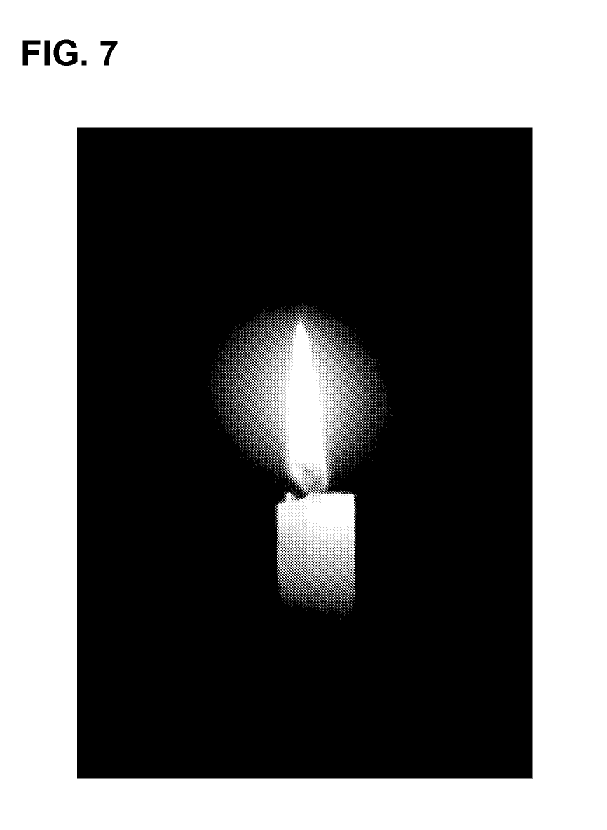

FIG. 7 is a photograph of an actual candle flame, that is, a real, non-simulated candle flame, which is simulated by aspects of the invention.

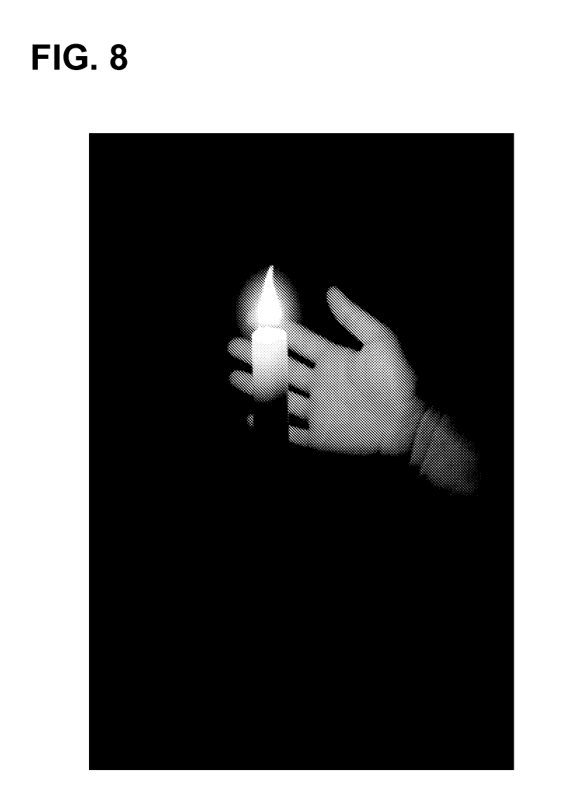

FIG. 8 is a photograph of a simulated candle according to an aspect of the invention as the aspect illuminates a hand. As shown, aspects of the invention provide a realistic and convincing simulation of the actual candle shown in FIG. 7.

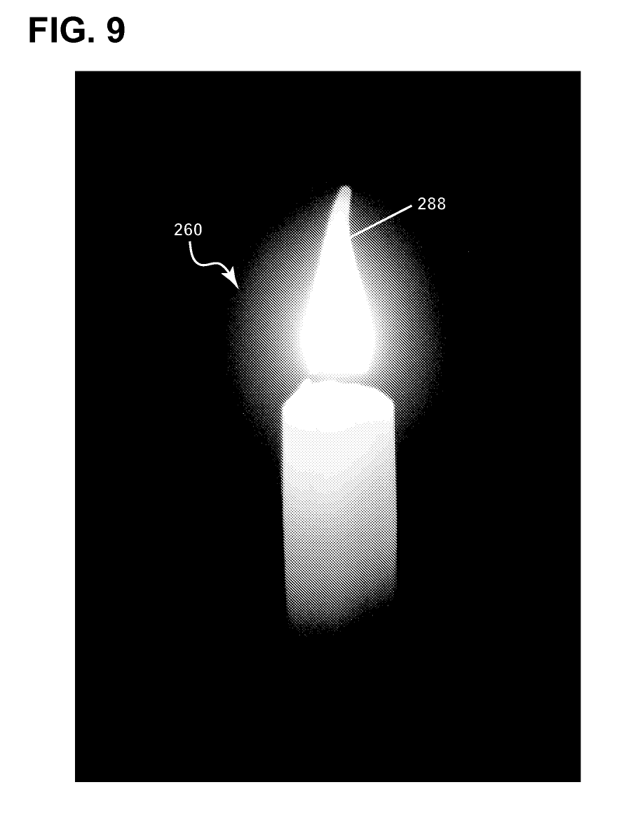

FIG. 9 is a photograph of a simulated candle 260 according to an aspect of the invention. As shown in FIG. 9, simulated candle 260 may include a light diffuser 288, for example, a light diffuser similar to diffusers 58, 88, and 188, described above. Light diffuser 288 is mounted about optic fibers to diffuse the light emitted by optic fibers and more accurately portray the appearance of a candle flame. According to an aspect of the invention, the function of the light diffuser 288 is to diffuse and blend at least some of the light emitted by the optic fibers (for example, the blue and amber light of the fibers with the white light emitted from the optic fibers). The diffuser 288 may also be shaped to provide the appearance of a candle flame. For example, light diffuser 288 may be a conical in shape and hollow interior to accommodate the internal fibers. The diffuser 288 may be made from an elastomer, for example, a rubber; a plastic; a ceramic; or glass and have an appropriate translucence to provide at least some diffusion of the light emitted by the optic fibers. In one aspect, diffuser 288 may be made from a translucent rubber. Light diffuser 288 may also function to protect the optic fibers and light sources from damage, for example, should the candle be dropped.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A simulated candle comprising:
a cylindrical housing having an open top;
a plurality of light sources positioned in the housing; and
a plurality of optical fibers having first ends positioned to receive and transmit light from the plurality of light sources and second ends projecting through the open top of the housing;
wherein the second ends of the plurality of optical fibers are arranged to simulate a candle flame.

2. The candle as recited in claim 1, wherein the plurality of light sources comprise a plurality of light-emitting diodes (LEDs).

3. The candle as recited in claim 1, wherein the candle further comprises a light diffuser mounted about the plurality of optical fibers.

4. The candle as recited in claim 3, wherein the light diffuser comprises a conical light diffuser.

5. The candle as recited in claim 1, wherein the plurality of light sources are positioned in the housing.

6. The candle as recited in claim 1, wherein the candle further comprises a power supply and a light controller position in the housing.

7. The candle as recited in claim 1, wherein the candle further comprises at least one optical fiber positioned to illuminate a translucent portion of the housing.

8. The candle as recited in claim 1, wherein at least some of the plurality of optical fibers are twisted together to intermingle colored light transmitted by the at least some of the plurality of optical fibers.

9. The candle as recited in claim 1, wherein the plurality of light sources emit a plurality of colors of light.

10. The candle as recited in claims 9, wherein the plurality of colors of light comprise at least blue, amber, and white.

11. The candle as recited in claim 1, wherein the candle comprises a simulated spermaceti candle.

12. A method of simulating a candle comprising:
positioning a plurality of optic fibers in a cylindrical housing having an open top whereby the plurality of optics fibers have first ends in the housing and second ends extending through the open top of the housing;
directing light from a plurality of light sources into the first ends of the plurality of optic fibers, transmitting the light through the plurality of optic fibers, and emitting the light transmitted out the second ends of the plurality of optic fibers; and
diffusing the light emitted out of at least some the second ends of the plurality of optic fibers to simulate a flame of a candle.

13. The method as recited in claim 12, wherein the plurality of light sources comprise a plurality of LEDs of varying color.

14. The method as recited in claim 13, wherein the LEDs comprise at least one amber LED, at least one blue LED, and at least one white LED.

15. The method as recited in claim 12, wherein the method further comprises transmitting light emitted from the second ends of at least some of the plurality of optic fibers though a translucent portion of the top of the housing to simulate a candle.

16. A simulated candle comprising:
a cylindrical housing having an open top;
a plurality of LEDs positioned in the housing;
a plurality of optical fibers having first ends positioned to receive and transmit light from the plurality of LEDs and second ends projecting through the open top of the housing and emitting the light received from the plurality of LEDs; and
a conical light diffuser mounted about the second ends of the plurality of optical fibers;
wherein the second ends of the plurality of optical fibers are arranged within the light diffuser wherein the light emitted from the plurality of LEDs simulates a candle flame.

17. The simulated candle as recited in claim 16, wherein the plurality of LEDs emit a plurality of colors of light.

18. The simulated candle as recited in claims 17, wherein the plurality of colors of light comprise at least blue, amber, and white.

19. The simulated candle as recited in claim 18, wherein at least some of the plurality of optical fibers are twisted together to intermingle the blue, amber and white colors emitted by the LEDs.

20. The simulated candle as recited in claim 16, wherein the candle comprise a simulated spermaceti candle.
